(19) United States
(12) Patent Application Publication
(10) Pub. No.: US 2007/0048041 A1
(43) Pub. Date: Mar. 1, 2007

(54) Heating device for fixing

(75) Inventor: Toru Odagaki, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA, Tokyo (JP)

(21) Appl. No.: 11/508,146

(22) Filed: Aug. 23, 2006

(30) Foreign Application Priority Data
Aug. 25, 2005 (JP) JP2005-244052

(51) Int. Cl. G03G 15/20

(52) U.S. Cl. 399/328; 399/330

(57) ABSTRACT

In a heating device for fixing, an incandescent lamp having a filament along the axis of a tubular container is provided. The heating device has a reflective mirror having an opening on a light emitting side thereof, which is provided along the axis of the incandescent lamp, and a condenser lens which is provided over the opening of the reflective mirror.

### CROSS-REFERENCES TO RELATED APPLICATION

This application claims priority from Japanese Patent Application Serial No. 2005-244052 filed on Aug. 25, 2005, the contents of which are incorporated herein by reference in its entirety.

### TECHNICAL FIELD

The present invention relates to a heating apparatus used for a toner image fixing apparatus in for example, an electrophotography copying machine, a laser beam printer, facsimile, etc.

### BACKGROUND

In a conventional electrophotography copying machine etc., a fixing apparatus having a heating roller and a pressure roller which are disposed so as to face each other, is provided, in which an unfixed toner image is fixed on a recording sheet by passing the recording sheet on which the unfixed toner image is formed, between the rollers.

Such a heating roller type fixing apparatus is described below, referring to FIG. 8.

The heating roller has a cylindrical roller core made of aluminum, in which an incandescent lamp is arranged so as to serve as a heat source. The roller core is heated by light emitted from the incandescent lamp. The pressure roller has a core rod made of SUS (Steel Use Stainless) on which a fluorine-contained rubber layer is formed. A recording sheet on which unfixed toner image is formed is winded in between the heating roller and the pressure roller, so that the toner is fixed by heat and pressure.

Such technology is disclosed in Japanese Laid Open Patent No. 2001-126846.

In such a fixing apparatus, the incandescent lamp is arranged in the inner space of the roller core, in which the roller core is heated by light emitted from the incandescent lamp. Although what is necessary is that the incandescent lamp intensively heat a portion (a portion “a” in the figure) where the heating roller and the pressure roller face each other, the light from the incandescent lamp is radiated (emitted radially), so that the entire roller core is heated. Thus, there is a problem that the light radiated from the incandescent lamp is not efficiently used in order to fix toner by heat.

Moreover, in such a fixing apparatus, it is required that a surface temperature of the heating roller reach the operational temperature (capable of fixing toner on a sheet by heating) for a short time immediately after the main switch of the apparatus is turned on, and further, the attainment time is required to be shorten to the second.

However, since the entire roller core is heated by the light radiated from the incandescent lamp, in order to raise the surface temperature of the heating roller, the energy is used so that the entire roller core including a portion where the heating roller and the pressure roller do not face each other is warmed up. Thus, there is a problem that the surface temperature of the heating roller cannot be raised to the operational temperature (capable of fixing toner by heating) for a very short time.

### SUMMARY

In view of such a problem, according to the present invention, it is possible to efficiently use light radiated from an incandescent lamp, and it is possible to heat only a portion to be heated. In case that a fixing apparatus according to the present invention is used as a heating source of an electrophotgraphy copying machine, the surface temperature of a portion of the heating roller which is used to fix toner on a sheet can be raised to the operational temperature for a short time. When the present invention is used for a heat source of a fixing apparatus such as an electronic copying machine, it is possible to raise the surface temperature of the heating roller which is used for fixing toner for a short time, to the operational temperature.

The present heating device for fixing, in which an incandescent lamp having a filament along a container axis of a tubular container is provided, comprises a reflective mirror having a gutter like shape and an opening on a light emitting side thereof, which is provided along a tube axis of the incandescent lamp; and a condenser lens which is provided over the opening of the reflective mirror.

Further, the heating device for fixing may include supporting members which are located both sides of the reflective mirror, wherein sealing portions of the incandescent lamp, engagement portions of the reflective mirror, and both ends of the condenser lens are inserted, so that the incandescent lamp, the reflective mirror, and the condenser mirror are held by the supporting members.

In the heating device for fixing according to the present invention, a gutter-like reflective mirror is disposed along with the tube axis of the incandescent lamp so that the bulb may be surrounded thereby, and the condenser lens is disposed over the entire opening of the reflective mirror on the light emitting side thereof. The light emitted from the incandescence bulb can be efficiently reflected by the reflective mirror, so that it is possible to lead light to the light emitting side opening, and further a predetermined heating area can be intensively and efficiently heated with the condenser lens provided over the entire opening in the light emitting side thereof.

Since the support members are located in the both sides of the reflective mirror and the incandescent lamp, and the reflective mirror and the condenser lens are held by the support members so as to form a structural unit, it is easy to deal with the heating device for fixing, and in case that the heating device is used as a heating source of the fixing apparatus of, for example, an electrophotography copying machine, the heating device for fixing can be easily arranged in a heating roller.

### BRIEF DESCRIPTION OF DRAWINGS

Other features and advantages of the present heating device will be apparent from the ensuing description, taken in conjunction with the accompanying drawings, in which:

FIG. 1 is a diagram of a fixing apparatus of the electronic copying machine using a heating device for fixing according to the present invention;

FIG. 2 is a diagram of a heating device for fixing according to the present invention;

FIGS. 3A and 3B are a side elevational view and a front view of a heating device for fixing according to the present invention, respectively;

FIG. 4 shows a perspective view of a heating device for fixing according to the present invention;

FIG. 5 is a graph showing an experimental data of a heat distribution radiation intensity of a comparative heating device for fixing, and a heating device for fixing according to the present invention;

FIG. 6 show data of a temperature raising experiment of a heating roller in which each of a comparative heating apparatus for heating and a heating device for fixing according to the present invention is built in heating apparatus of an electrophotography copying machine;

FIG. 7 is a cross-sectional view of another embodiment of a heating device for fixing according to the present invention; and

FIG. 8 is a diagram of a fixing apparatus according to the conventional heating roller system.

### DETAILED DESCRIPTION

While the claims are not limited to the illustrated embodiments, an appreciation of various aspects of the present heating device is best gained through a discussion of various examples thereof.

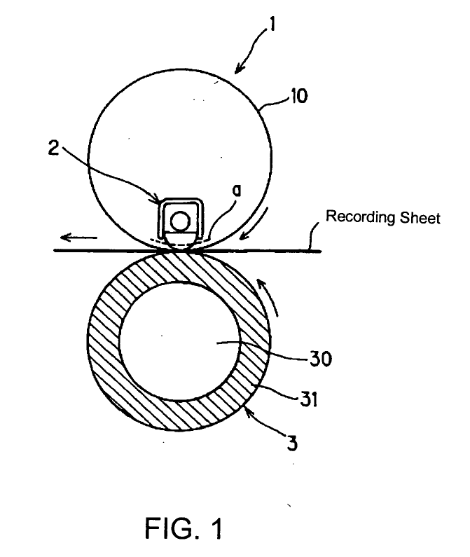

FIG. 1 is a diagram of a fixing apparatus of an electrophotography copying machine in which a heating device for fixing according to the present invention is provided.

A heating roller 1 has a cylindrical roller core 10 made of aluminum, and a heating device 2 for fixing according to the present invention is arranged in the roller core 10. A pressing roller 3 has a core rod 30 made of SUS on which a fluorine-contained rubber layer 31 is formed. And a recording sheet on which toner is formed is winded in between the heating roller and the pressure roller, so that the toner is fixed on the sheet by heat and pressure.

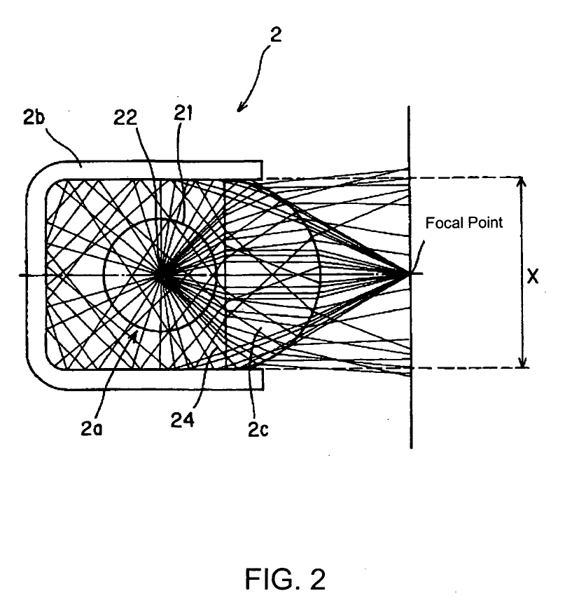

FIG. 2 is a diagram of the heating device for fixing according to the present invention.

In the heating device 2, an incandescent lamp 2a which has a filament 22 in a tubular enclosure member 21 along with the tube axis thereof, and a gutter-like reflective mirror 2b having an approximately U-shape in a cross-sectional view is provided along with the tube axis of the incandescent lamp 2a, in which reflective mirror 2b has an opening 24 from which light is emitted. And a condenser lens 2c is provided so as to cover the opening 24 so that the opening 24 may be closed. A condenser lens 2c is made of quartz glass, and is semicircle shaped in a cross-sectional view in which a face of the lens 2c facing the incandescent lamp has a flat surface.

Each component will be explained in detail below.

The incandescent lamp 2a is 270 mm in full length, 6 mm in outer diameter, 4 mm in inner diameter, and is a halogen incandescent lamp which is turned on at rating, 1.5A and 150W.

The reflection mirror 2b is made of SUS, and the length in the longitudinal direction is 231 mm and the width X of the opening is 10.5 mm.

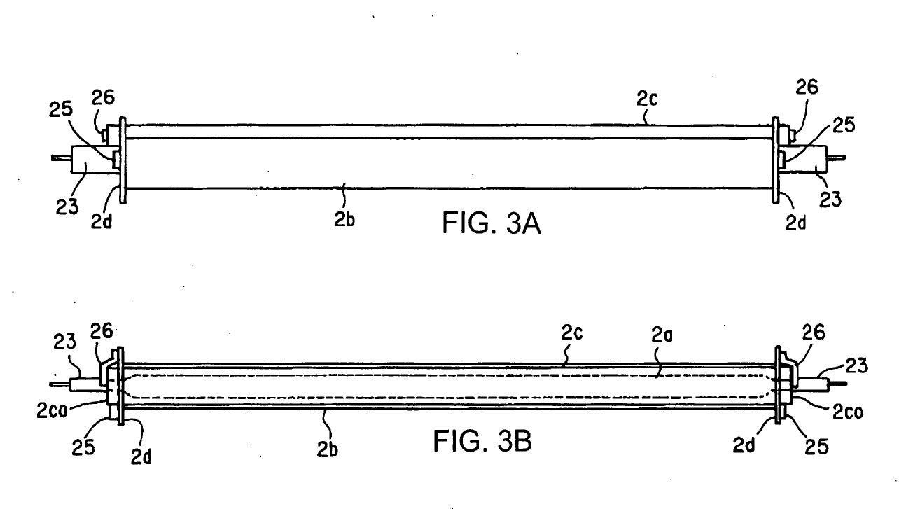

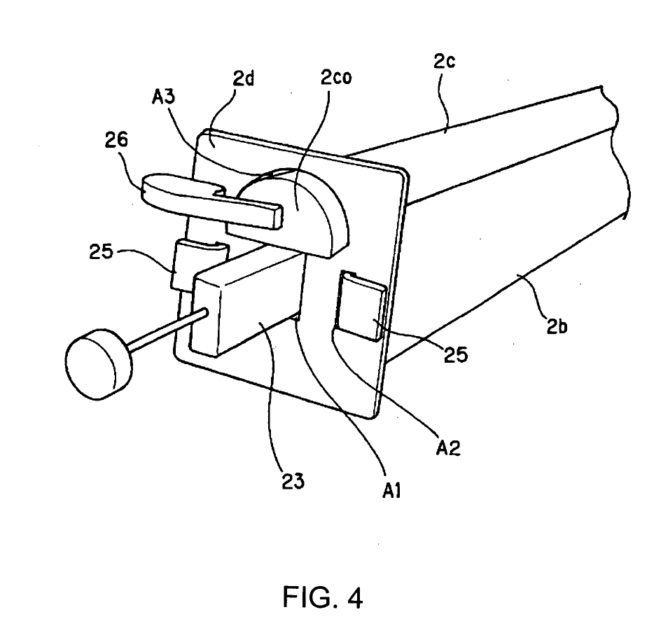

FIGS. 3A and 3B show a front view and a top plan view of the heating device for fixing according to the present invention respectively, and FIG. 4 shows a perspective view of the heating device for fixing according to the present invention.

Support members 2d made of SUS are located on the both sides of the reflective mirror 2b. Each of the support members 2d has an electric bulb fixing hole A1. A sealing portion 23 located at each end of the incandescent lamp 2a is inserted in the electric bulb fixing hole A1 so that the incandescent lamp 2a is held by the support members 2d.

Moreover, each of the support members 2d has mirror fixing holes A2. Engagement portions 25 formed at both ends of the reflective mirror 2b are inserted in the mirror fixing holes A2 respectively, and the engagement portions 25 are bent toward the surface of the supporting members 2d respectively so that the reflective mirror 2b is held on the support members 2d.

Furthermore, each of the support members 2d has a lens fixing hole A3. Both end sides of a condenser lens 2e are inserted in the lens fixing holes A3 respectively and a spring member 26 comes in contact with each end face 2co of the condenser lens 2c, so that the condenser lens 2e is held on the support members 2d.

In such a heating device for fixing, since, as shown as ray trajectory in FIG. 2, light emitted from the incandescence lamp 2a is reflected by the reflective mirror 2b, or directly enters into the condenser lens 2c, so as to be condensed in front of the opening in the light emitting side of the reflective mirror 2b due to the condensing action of the condenser lens 2c, as shown in FIG. 1. When the heating device for fixing according to the present invention is installed in a fixing apparatus of a copying machine, as shown by “a” of FIG. 1, it is possible to intensively and efficiently heat a portion where the heating roller and the pressure roller face each other.

Furthermore, in the heating device for fixing according to the present invention, since the incandescent lamp 2a, the reflective mirror 2b, and the condenser lens 2c are held by the support members 2d so as to form one structural unit, it is easy to deal with it and in case it is used as a heat source of a fixing apparatus, it is possible to simplify an attachment process thereof when the heating device for fixing is installed in the heating roller which form a fixing apparatus.

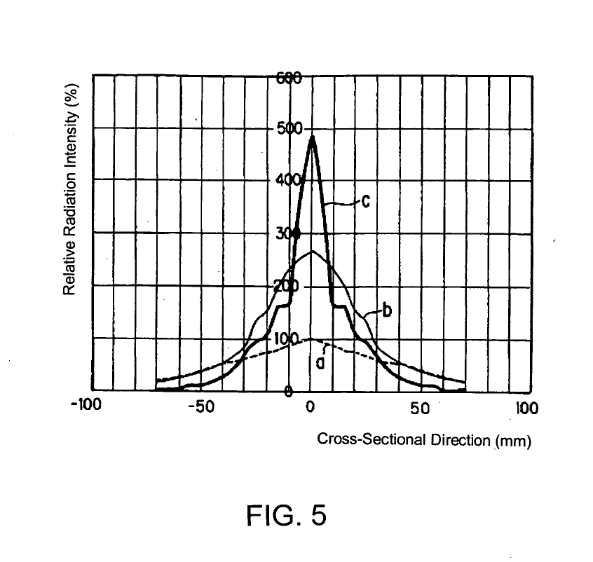

FIG. 5 is a diagram showing experiment data of the heat distribution radiation intensity in a cross-sectional direction of the heating device for fixing shown in FIGS. 1-4 and comparative heating apparatuses.

The specification and the experimental result of the heating device for fixing used for this experiment are shown in Table 1 below.

TABLE 1

| | Heat Source | Reflective Mirror | Condensing Lens | Data |
|---|---|---|---|---|
| Comparative | Tubular | N/A | N/A | Curve a in |
| Heating Device 1 | Halogen | | | the graph |
| | Incandescent | | | of FIG. 5 |
| | lamp Rating | | | |
| | 1.5 A, 150 W | | | |
| Comparative | Tubular | SUS gutter-like | N/A | Curve b in |
| Heating Device 2 | Halogen | mirror having | | the graph |
| | Incandescent | U-shape in cross | | of FIG. 5 |
| | lamp Rating | section and | | |
| | 1.5 A, 150 W | surrounding | | |
| | | tubular halogen | | |
| | | incandescent | | |
| | | lamp | | |
| Present | Tubular | SUS gutter-like | Quartz glass semi | Curve c in |
| Heating Device | Halogen | mirror having | cylindrical | the graph |
| | Incandescent | U-shape in cross | condensing mirror | of FIG. 5 |
| | lamp Rating | section and | having a | |
| | 1.5 A, 150 W | surrounding | semicircle in a | |
| | | tubular halogen | cross-section and | |
| | | incandescent | closing opening of | |
| | | lamp | the reflective | |
| | | | mirror | |

The radiation intensity was measured, while an optical sensor was moved in a direction perpendicular to the tube axis of the tubular halogen incandescent lamp at a position which was 28.5 mm away in a vertical direction from the center of a cross section of the halogen incandescent lamp which was taken along a line perpendicular to the axis of the incandescent lamp. In the figure, a position 0 mm on the horizontal axis represents the center of the cross section of the halogen incandescent lamp, and the vertical axis represents relative radiation intensity when the radiation intensity of the comparative heating device for fixing at the 0 mm position is regarded as 100%.

Neither a reflective mirror nor a condense mirror was provided in a comparative heating device 1 for fixing, whose relative radiation intensity is shown as a curve “a” in FIG. 5, but only a halogen incandescent lamp is merely provided. As shown as the curve “a”, although the maximum radiation intensity at the center of the cross section of the halogen incandescent lamp is regarded as 100%, the curve shows a smooth curve having a peak at the middle (mountain like shape). Thus, it turns out that the light emitted from the halogen incandescent lamp was not condensed.

The comparative heating device 2 for fixing whose relative radiation intensity was shown as a curve “b” in FIG. 5 comprised a halogen incandescent lamp and a reflective mirror. As shown in the curve “b”, the maximum intensity of radiation was 270% at a position where the cross section center position of the halogen incandescent lamp was 0 mm. The maximum radiation intensity thereof rose by 2.7 times as much as that of the comparative heating device 1. Moreover, it turns out that the light emitted from the halogen incandescent lamp was slightly condensed by the reflective mirror, and the condensing ability thereof was improved, compared with the comparative heating device 1.

The heating device for fixing according to the present invention whose relative radiation intensity was shown as a curve “c” in FIG. 5 comprised a halogen incandescent lamp, a reflective mirror, and a condenser mirror. As shown in curve c, the maximum intensity of radiation was 490% at a position where the cross section center position of the halogen incandescent lamp was 0 mm. The maximum radiation intensity thereof rose by 1.8 times as much as that of the comparative heating device 2, and by 4.9 times as much as that of the heating device 1. Moreover, the light emitted from the halogen incandescent lamp was intensively condensed at a position where the cross section center position of the halogen incandescent lamp was 0 mm, by action of the reflection mirror and the condenser lens. The curve “c” shows a clearly steep curve around the peak, compared with curves a and b, whereby it turns out that the light emitted from the halogen incandescent lamp was condensed effectively, so that the condensing ability is improved.

As shown from the experiment, since the reflective mirror and the condenser lens were used for the light source apparatus for fixing according to the present invention, light radiated from the halogen incandescent lamp was efficiently reflected by the reflective mirror so as to lead it to a light emitting side opening, and a predetermined heating area could be efficiently intensively heated by the condenser lens provided over the entire opening or approximately the entire opening on the light emitting side.

Next, an experiment in which the temperature of a heating roller was raised was conducted in which the comparative heating device for fixing shown in the above-mentioned table 1 and the heating device for fixing according to the present invention were installed in an electrophotgraphy copying machine invention respectively.

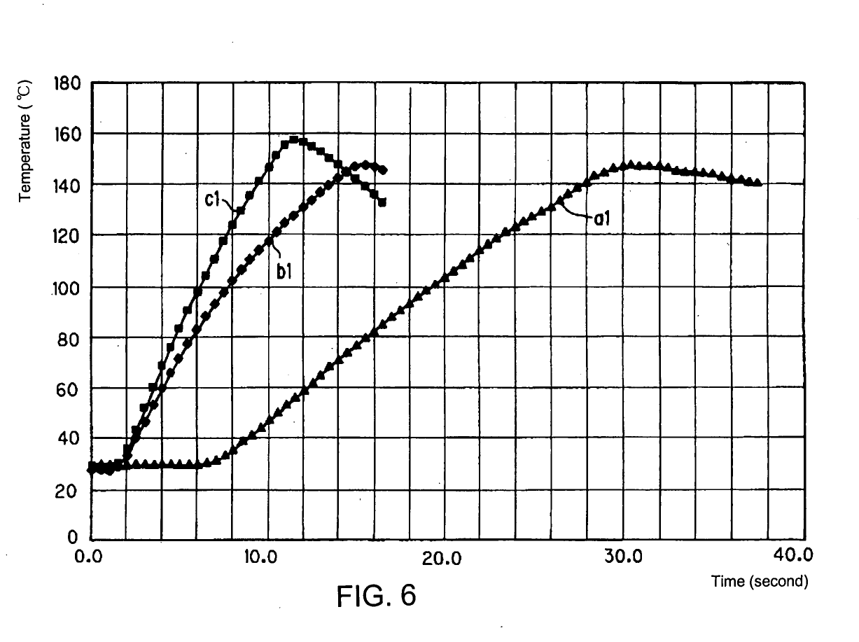

The result of the experimental is shown in FIG. 6. The heating roller was the same as that shown in FIG. 1, in which the diameter thereof was 20 mm, a cylindrical roller core made of aluminum had a 0.8 mm thickness.

In the experiment, in which the comparative heating device 1 for fixing was used, a halogen incandescent lamp was arranged on the inner central axis of the roller core. The experimental result is shown in a curve “a1” in FIG. 6. In the experiment, in which the heating device for fixing according to the present invention was used, the heating device for fixing was arranged so that a condenser lens was located at a position which was 1 mm away from an inner face of the roller core that the pressure roller faced. The experimental result is shown in a curve “c1” of FIG. 6. In the experiment in which the comparative heating apparatus 2 for fixing was used, the position of the heating device for fixing was arranged in the same position as the heating device according to the present invention, wherein a condenser lens was not attached thereto. A curve “b1” of FIG. 6 shows the experimental result.

In this experiment, when the surface of the roller core reached 140 degrees Celsius, the roller was regarded as operational, that is, the roller was regarded as reaching the operational temperature (capable of fixing toner on a sheet by heating). While in the fixing apparatus using the comparative heating apparatus 1, it took 28 seconds for the surface of the roller core to reach the operational temperature capable of fixing toner on a sheet by heating, in the fixing apparatus using the comparative heating device 2, it took 13.5 seconds for the surface of the roller core to reach the operational temperature capable of fixing toner on a sheet by heating. Thus, the starting up time could not be shortened so as to be shorter than 10 second which is the requirement for starting up time of short time starting up models in the industry. On the other hand, in the fixing apparatus using the heating device according to the present invention, the surface temperature of the roller core reached the operational temperature capable of fixing toner on a sheet by heat, in 9.5 seconds, whereby the starting up time could be shortened so as to meet the industrial requirement of less than 10 seconds.

That is, in the heating device for fixing according to the present invention, light radiated from the incandescent lamp is condensed at the portion where the heating roller and the pressure roller face each other so that the heat is efficiently used and it is possible to raise, to the operational temperature, the surface temperature of the heating roller which is used for fixing toner for a short time.

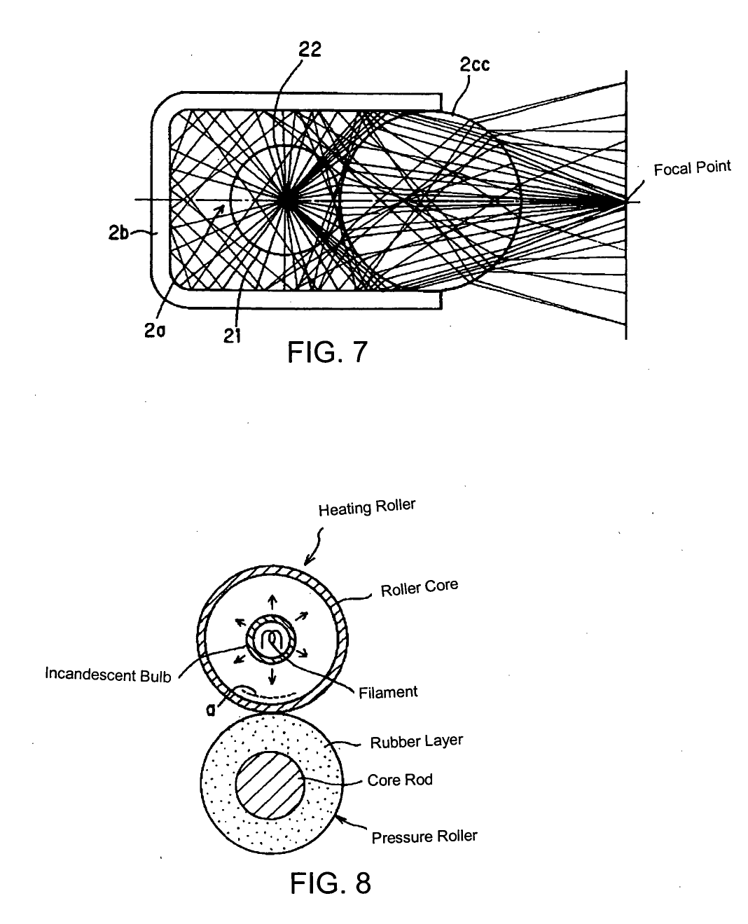

FIG. 7 is a cross-sectional view of a heating device for fixing according to another embodiment of the present invention, in which a cylindrical condenser lens 2cc made of quartz glass is provided, and has a circle shape in a cross-sectional view thereof.

Even if this cylindrical lens is used, as shown in FIG. 7, the light emitted from the incandescent lamp and the light reflected by the reflective mirror inside can be condensed in front of the opening of the reflective mirror certainly. In addition, the structure of the incandescent lamp and the reflective mirror is the same as that shown in FIG. 2, and description thereof is omitted. In this condenser lens, compared with the lens having the semicircle shape in a cross-section shown in FIG. 2, a cutting process can be omitted, and a cylindrical quartz rod can be used as it is, so that the work thereof can be simplified and cost thereof can be reduced.

In addition, the heating device for fixing according to the present invention can be used as a heat source for heating a film of a surf-type fixing apparatus in which the heat source has a film shape, instead of using the cylindrical roller core made of aluminum in which the heating apparatus is installed.

The preceding description has been presented only to illustrate and describe exemplary embodiments of the heating device according to the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A heating device for fixing, in which an incandescent lamp having a filament along a container axis of a tubular container is provided, comprising:
a reflective mirror having a gutter like shape and an opening on a light emitting side thereof, which is provided along a tube axis of the incandescent lamp; and
a condenser lens which is provided over the opening of the reflective mirror.

2. The heating device for fixing according to claim 1, further including supporting members which are located both sides of the reflective mirror, wherein sealing portions of the incandescent lamp, engagement portions of the reflective mirror, and both ends of the condenser lens are inserted, so that the incandescent lamp, the reflective mirror, and the condenser mirror are held by the supporting member.

3. The heating device for fixing according to claim 1, wherein the condenser lens has a semicircle shape in a cross section.

4. The heating device for fixing according to claim 1, wherein the condenser lens has a circular shape in a cross section.

5. The heating device for fixing according to claim 1, wherein the reflective mirror comprises front wall and rear walls parallel to each other and one ceiling wall perpendicular to these two walls.

6. The heating device for fixing according to claim 5, wherein the reflective mirror further includes two side walls covering openings located in sides of the front and rear walls, and the ceiling wall wherein the opening of the reflective mirror formed by the front rear walls, the side walls and the ceiling wall, edges of these walls are set at the same height.

7. A heating device for a heating roller, comprising:
a reflective mirror having an opening on a light emitting side thereof; and
a condenser lens which is provided over the opening of the reflective mirror.

8. A fixing apparatus for fixing toner formed on a recording sheet, comprising:
a pressure roller;
a heating roller, wherein the pressure roller and the heating roller face each other;
wherein, in the heating roller, a reflective mirror having an opening on a light emitting side thereof and a condenser lens which is provided so as to cover the opening of the reflective mirror are provided.

9. The fixing apparatus according to claim 8, wherein supporting members are located both sides of the reflective mirror, and sealing portions of the incandescent lamp, engagement portions of the reflective mirror, and both ends of the condenser lens are inserted in holes provided in the supporting members.
